(19) United States
(12) Patent Application Publication
(10) Pub. No.: US 2024/0154232 A1
(43) Pub. Date: May 9, 2024

(54) BATTERY ENERGY STORAGE SYSTEM FIXED BY STEEL BELT

(71) Applicant: James Cheng Lee, La Habra, CA (US)

(72) Inventor: James Cheng Lee, La Habra, CA (US)

(21) Appl. No.: 18/198,862

(22) Filed: May 18, 2023

Related U.S. Application Data
(60) Provisional application No. 63/422,001, filed on Nov. 3, 2022.

(30) Foreign Application Priority Data
Apr. 11, 2023 (CN) 202320788788.1

(51) Int. Cl. H01M 50/264; H01M 10/613; H01M 50/209; H01M 50/227; H01M 50/293

(52) U.S. Cl. CPC H01M 50/264; H01M 10/613; H01M 50/209; H01M 50/227; H01M 50/293

(57) ABSTRACT

A battery energy storage system fixed by a steel belt is provided, comprising a plastic frame, a battery module, a steel belt, and a support element. The battery module is arranged inside the plastic frame and includes a plurality of batteries. The steel belt is arranged around the outer surface of the battery module and binds the batteries together. The support element is arranged on the outer side of the battery module or the inner side of the plastic frame and abuts against the bottom of the steel belt. The plastic frame protects the battery module with low cost, light weight and good insulation effect. The steel belt can limit and fix the batteries, thereby increasing the restraint and fastening force on the battery module and increasing the structural strength to satisfy safety regulations. Furthermore, the support element supports the steel belt to prevent the steel belt from sliding down.

### BACKGROUND OF THE INVENTION

### 1. Field of the Invention

The present invention relates generally to a battery energy storage system, and more particularly, to a battery energy storage system fixed by steel belt.

### 2. The Prior Arts

With the development of renewable electricity, battery energy storage systems (BESS) have gradually become one of the important technologies. Battery energy storage systems are currently widely used in environments such as residential or commercial buildings to raise the bar for feasibility in the field of renewable electricity.

A known battery energy storage system includes a steel frame and a battery module, and the battery module is arranged inside the steel frame. However, the steel frame has problems of high cost, bulkiness and poor insulation effect.

The first known fixing method of the battery module is to manually surround a plurality of plastic partitions on the outside of the battery module, and then manually bind the nylon belt between the plastic partition and the battery. Finally, on the outside of the module, the two ends of the nylon belt are welded into one by ultrasonic welding. However, the resulted battery module is bulky and difficult to assemble manually.

The second known fixing method of the battery module is to provide a plurality of fixing screws on the casing, and then manually lock the fixing screws on the plurality of batteries in the battery module to increase the fastening force of the batteries. However, the number of fixing screws is quite large, the cost is high, and manual assembly is difficult.

### SUMMARY OF THE INVENTION

A primary objective of the present invention is to provide a battery energy storage system fixed by steel belt, which can provide a frame with low cost, light weight and good insulation effect, and can limit and fix the battery batteries with a steel belt.

Another objective of the present invention is to provide a battery energy storage system fixed by steel belt, which can support the steel belt without fixing screws.

In order to achieve the aforementioned objectives, the present invention provides a battery energy storage system fixed by steel belt, including a plastic frame, a battery module, and at least one steel belt; wherein the battery module is arranged inside the plastic frame and includes a plurality of batteries; the at least one steel belt is arranged around an outer surface of the battery module along a circumferential direction and binds the batteries together.

In a preferred embodiment, the battery energy storage system fixed by steel belt further includes at least one support element, which is arranged on the outer surface of the battery module or an inner surface of the plastic frame, and abuts against a bottom of the at least one steel belt.

In a preferred embodiment, when the at least one support element is disposed on the outer surface of the battery module, an extension direction of the at least one support element is parallel to an extension direction of the at least one steel belt.

In a preferred embodiment, the at least one support element is a fiber glass board.

In a preferred embodiment, when the at least one support element is disposed on the inner surface of the plastic frame, an extension direction of the at least one support element is perpendicular to an extension direction of the at least one steel belt.

In a preferred embodiment, the plastic frame is integrally formed with the at least one support element.

In a preferred embodiment, the battery energy storage system fixed by steel belt further includes a plurality of steel belts and a plurality of support elements; wherein, the plurality of steel belts at least include a first steel belt and a second steel belt, and the second steel belt is located below the first steel belt; wherein, the plurality of support elements include at least two first support elements and four second support elements, the first support elements are respectively arranged on the an outer surface of the two batteries at both ends of the battery module and abut against a bottom of the two ends of the first steel belt, and the second support elements are respectively arranged on the two inner surfaces of the two ends of the plastic frame and abut against a bottom of the two ends of the second steel belt.

In a preferred embodiment, the inside of the plastic frame is divided into a plurality of compartments, and the batteries are respectively arranged in the compartments.

In a preferred embodiment, the plastic frame includes four side panels, a plurality of partitions, and a plurality of ribs, the four side panels jointly form an accommodating space, and the partitions divide the accommodating space into the plurality of equal compartments, the ribs are arranged on an inner surface of the side panels and an inner surface of the partitions, and a plurality of side surfaces of each battery respectively abut against the ribs.

In a preferred embodiment, each side panel defines a plurality of cooling holes, and the accommodating space communicates with the cooling holes.

The effect of the present invention is that the plastic frame can protect the battery module and has the advantages of low cost, light weight, and good insulation effect and the steel belt increases the restraint fastening force on the battery module as well as the overall structural strength to enable the battery energy storage system of the present invention to meet the relevant safety certification requirements.

Moreover, the support elements can support the steel belt, prevent the steel belt from sliding down, and does not need to provide fixing screws, which saves cost and is easy to assemble manually.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a correlation between components of a direction control apparatus according to an embodiment of the present invention;

FIG. 1 is a perspective view of the battery energy storage system of the present invention.

FIG. 2 is an exploded view of the battery energy storage system of the present invention.

FIG. 3 is a schematic view of area III in FIG. 2.

FIG. 4 is the top view of the plastic frame of the present invention.

FIG. 5 is a schematic view of area V in FIG. 4.

FIG. 6 is a cross-sectional view taken along line VI-VI of FIG. 1.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

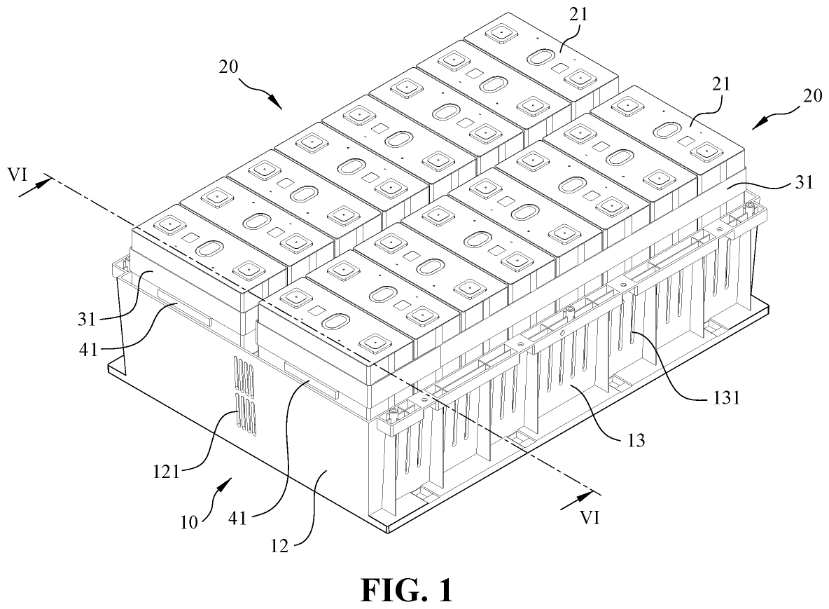

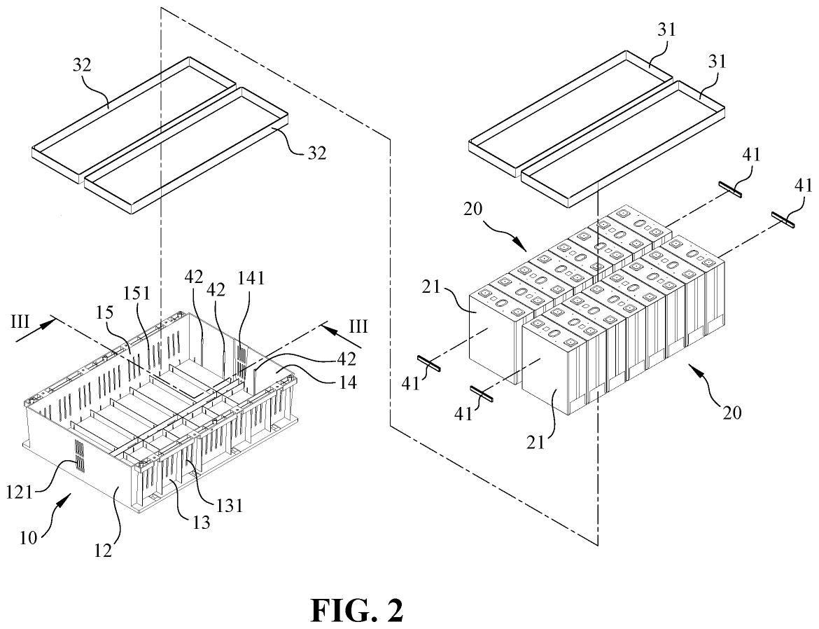

FIG. 1 is a schematic view of the battery energy storage system of the present invention, and FIG. 2 is an exploded view of the battery energy storage system of the present invention. As shown in FIG. 1 and FIG. 2, the present invention provides a battery energy storage system fixed by steel belts 31, 32, including a plastic frame 1, two battery modules 20, and a plurality of steel belts 31, 32. The battery modules 20 are disposed inside the plastic frame 10 and include a plurality of batteries 21. The steel belts 31, 32 are respectively arranged around an outer surface of the battery modules 20 along a circumferential direction and bind the batteries 21 together. Thereby, the plastic frame 10 can protect the battery modules 20 and has the advantages of low cost, light weight, and good insulation effect. The steel belts 31, 32 increase the restraint and fastening force on the battery modules 20 and enhance the overall structural strength so that the battery energy storage system of the present invention can meet the certification requirements of relevant safety regulations.

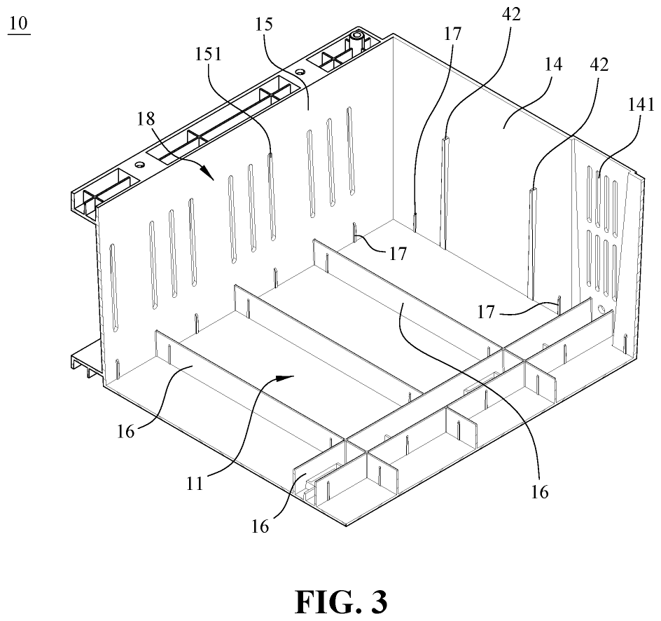

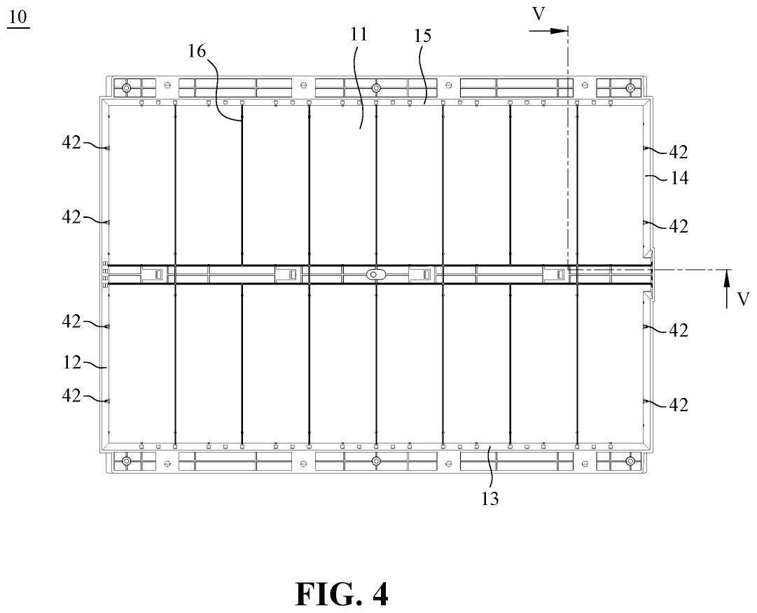

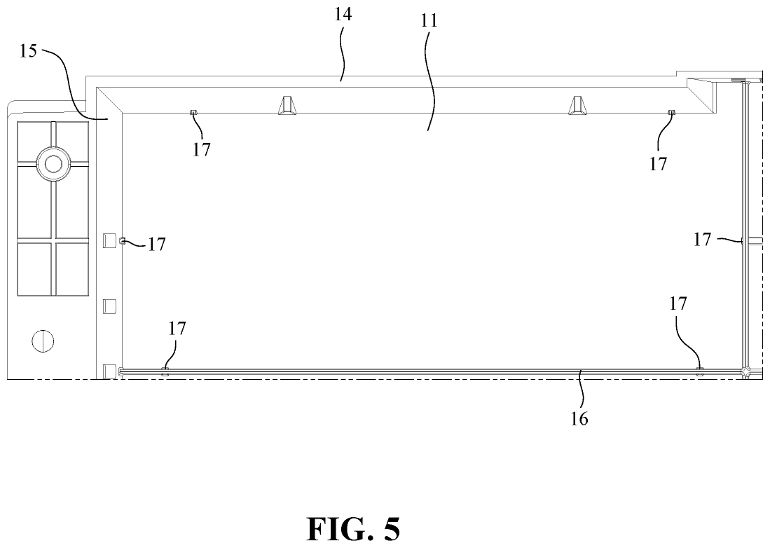

FIG. 3 is a schematic view of area III in FIG. 1, FIG. 4 is a top view of the plastic frame 10 of the present invention, and FIG. 5 is a schematic view of area V in FIG. 4. As shown in FIGS. 2 to 5, in a preferred embodiment, the inside of the plastic frame 10 is divided into a plurality of compartments 11, and the batteries 21 are respectively disposed in the compartments 11. As such, the plastic frame 10 can individually position each single battery 21, and the user can easily install each battery 21 in each compartment 11.

Preferably, the plastic frame 10 includes four side panels 12-15, a plurality of partitions 16, and a plurality of ribs 17; wherein the side panels 12-15 together form an accommodating space 18, the partitions 16 will divide the accommodating space 18 into the plurality of compartments 11, and the ribs 17 are arranged on an inner surface of the side panels 12-15 and an inner surface of the partitions 16 so that a plurality of sides of each battery 21 abut respectively against the ribs 17. Thereby, the ribs 17 can position the battery 21 in each compartment 11, to prevent the batteries 21 from shaking, and improve the stability of the batteries 21.

Preferably, each side plate 12-15 is provided with a plurality of cooling holes 121, 131, 141, 151, and the accommodating space 18 communicates with these cooling holes 121, 131, 141, 151. As such, the cooling holes 121, 131, 141, 151 can keep the accommodating space 18 and the external space ventilated, which helps to reduce the temperature of the batteries 21.

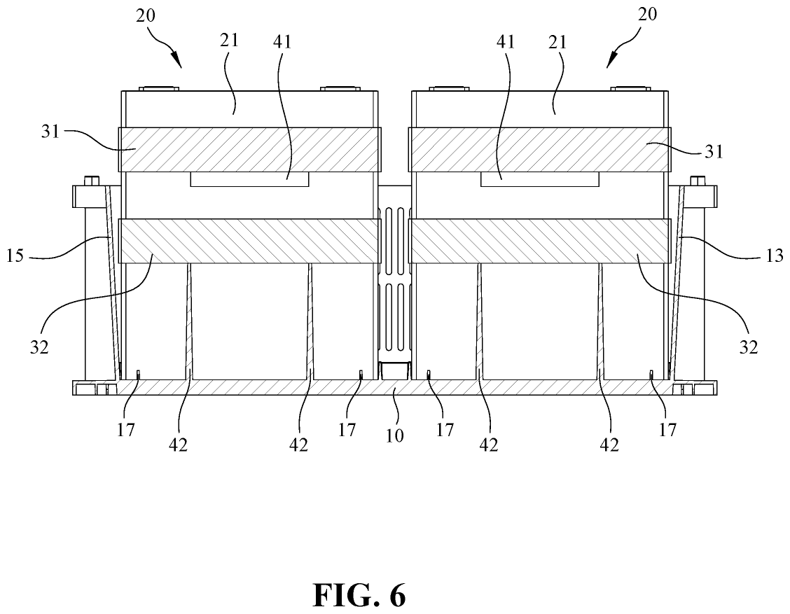

FIG. 6 is a cross-sectional view of line VI-VI in FIG. 1. As shown in FIGS. 1-6, the battery energy storage system of the present invention further includes a plurality of support elements 41, 42, and the support elements 41, 42 are respectively arranged on an outer surface of the battery modules 20 and an inner surface of the plastic frame 10 and abut against the bottoms of the steel belts 31, 32. Thereby, the support elements 41, 42 can support the steel belt 31, 32, prevent the steel belt 31, 32 from sliding down, without the need to provide fixing screws, which saves cost, and enable easy manual assembly.

More specifically, the plurality of steel belts 31, 32 include two first steel belts 31 and two second steel belts 32, and the plurality of support elements 41, 42 include four first support elements 41 and eight second support elements 42. The first steel belts 31 are respectively arranged around the outer surfaces of the battery modules 20 along the circumferential direction to bundle the batteries 21 together, and the second steel belts 32 are respectively arranged around the outer surfaces of the battery modules 20 along the circumferential direction to bundle the batteries 21 together, and the second steel belts 32 are located under the first steel belts 31 respectively. Two of the first support elements 41 are respectively arranged on an outer surface of the two batteries 21 at both ends of one of the battery modules 20 and abut against the bottom of two ends of one of the first steel belt 31. The other two of the first support element 41 are respectively arranged on an outer surface of the two batteries 21 at the two ends of the other battery module 20 and abut against the bottom of the two ends of other first steel belt 31. The second support elements 42 are respectively arranged on the two inner surfaces of the two ends of the plastic frame 10, and four of the second support elements 42 respectively abut against the bottoms of the two ends of one of the second steel belts 32, and the other four of the second support elements 42 respectively abut against the bottoms of the other two ends of the second steel belt 32.

Thereby, the first steel belt 31 and the second steel belt 32 can jointly hold the batteries 21 in position, so as to increase the restraint fastening force on the battery modules 20 and increase the overall structural strength so that the battery energy storage system of the present invention can meet the certification requirements of relevant safety regulations.

Furthermore, the first support elements 41 can support the first steel belts 31, and the second support elements 42 can support the second steel belts 32, to prevent the first steel belts 31 and the second steel belts 32 from sliding down without the need to use fixing screws, which saves cost and enable easy manual assembly.

In some embodiments, the number of the first support elements 41 is more than four and all are respectively arranged on the outer surfaces of the two ends of the battery 21. The first support elements 41 in these embodiments have a better effect of jointly supporting the first steel belts 31 and can prevent the first steel belts 31 from sliding down, but the cost is higher.

In some embodiments, the number of the second support elements 42 is more than four and all are respectively disposed on the inner surface of the plastic frame 10. In these embodiments, the effect of the second support elements 42 supporting the second steel belts 32 is better, and the second steel belts 32 can be prevented from sliding down, but the cost is higher.

As shown in FIG. 1, FIG. 2, and FIG. 6, in a preferred embodiment, an extension direction of each first support member 41 is parallel to an extension direction of each first steel belt 31. Therefore, the first support elements 41 can stably support both ends of the first steel belt 31 together.

Preferably, the first supports 41 are glass fiber boards. The glass fiber has good strength and high temperature resistance, so the first support elements 41 have a good supporting effect and are not affected by the high temperature of the battery 21.

As shown in FIG. 2, FIG. 3, and FIG. 6, in a preferred embodiment, an extension direction of each second support member 42 is perpendicular to an extension direction of each second steel belt 32. Therefore, the second support elements 42 can stably support the two ends of the second steel belt 32 together.

Preferably, the plastic frame 10 and the second support elements 42 are integrally formed. In other words, the second support elements 42 are also plastic. The plastic has good strength, good insulation and high temperature resistance, so the second support elements 42 have good supporting effect and insulating effect, and are not affected by the high temperature of the battery 21.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A battery energy storage system fixed by steel belt, comprising:
a plastic frame;
a battery module, arranged inside the plastic frame and comprising a plurality of batteries; and
at least one steel belt; arranged around an outer surface of the battery module along a circumferential direction and binding the batteries together.

2. The battery energy storage system fixed by steel belt according to claim 1, further comprising at least one support element, arranged on the outer surface of the battery module or an inner surface of the plastic frame, and abutting against a bottom of the at least one steel belt.

3. The battery energy storage system fixed by steel belt according to claim 2, wherein when the at least one support element is disposed on the outer surface of the battery module, an extension direction of the at least one support element is parallel to an extension direction of the at least one steel belt.

4. The battery energy storage system fixed by steel belt according to claim 3, wherein the at least one support element is a fiber glass board.

5. The battery energy storage system fixed by steel belt according to claim 2, wherein when the at least one support element is disposed on the inner surface of the plastic frame, an extension direction of the at least one support element is perpendicular to an extension direction of the at least one steel belt.

6. The battery energy storage system fixed by steel belt according to claim 5, wherein the plastic frame is integrally formed with the at least one support element.

7. The battery energy storage system fixed by steel belt according to claim 2, further comprising a plurality of steel belts and a plurality of support elements; wherein, the plurality of steel belts at least comprising a first steel belt and a second steel belt, and the second steel belt being located below the first steel belt; wherein, the plurality of support elements comprising at least two first support elements and four second support elements, the first support elements being respectively arranged on the an outer surface of the two batteries at both ends of the battery module and abut against bottoms of the two ends of the first steel belt, and the second support elements being respectively arranged on the two inner surfaces of the two ends of the plastic frame and abut against bottoms of the two ends of the second steel belt.

8. The battery energy storage system fixed by steel belt according to claim 1, wherein the inside of the plastic frame is divided into a plurality of compartments, and the batteries are respectively arranged in the compartments.

9. The battery energy storage system fixed by steel belt according to claim 8, wherein the plastic frame comprises four side panels, a plurality of partitions, and a plurality of ribs, the four side panels jointly form an accommodating space, and the partitions divide the accommodating space into the plurality of equal compartments, the ribs are arranged on an inner surface of the side panels and an inner surface of the partitions, and a plurality of side surfaces of each battery respectively abut against the ribs.

10. The battery energy storage system fixed by steel belt according to claim 9, wherein each side panel is provided with a plurality of cooling holes, and the accommodating space communicates with the cooling holes.
